(19) United States
(12) Patent Application Publication
(10) Pub. No.: US 2025/0229609 A1
(43) Pub. Date: Jul. 17, 2025

(54) CINCHING DEVICE FOR DOOR LATCHES IN VEHICLE

(71) Applicants: Hyundai Motor Company, Seoul (KR); Kia Corporation, Seoul (KR)

(72) Inventors: Yongdae SEO, Hwaseong-Si (KR); Hyong Don KIM, Hwaseong-Si (KR)

(73) Assignees: Hyundai Motor Company, Seoul (KR); Kia Corporation, Seoul (KR)

(21) Appl. No.: 18/933,277

(22) Filed: Oct. 31, 2024

(30) Foreign Application Priority Data
Jan. 15, 2024 (KR) 10-2024-0006067

(51) Int. Cl. B60J 5/04; E05B 79/20; E05B 81/06; E05B 81/40

(52) U.S. Cl. CPC B60J 5/0479; E05B 79/20; E05B 81/06; E05B 81/40

(57) ABSTRACT

A cinching device for door latches in a vehicle, which performs cinching control for a plurality of latches, includes: a cinching actuator; a lead screw engaged to the cinching actuator and rotated by the cinching actuator; a lead nut assembly movably coupled to the lead screw; and a plurality of cable levers coupled to the lead nut assembly, and connected to the plurality of latches through respective cinching cables, wherein the cinching control is performed by absorbing a difference in cinching strokes of the plurality of latches through a spring structure.

### CROSS-REFERENCE TO RELATED APPLICATION

The present application claims priority to Korean Patent Application No. 10-2024-0006067 filed on Jan. 15, 2024, the entire contents of which is incorporated herein for all purposes by this reference.

### BACKGROUND OF THE PRESENT DISCLOSURE

### Field of the Present Disclosure

The present disclosure relates to a cinching device for door latches in a vehicle, and more particularly, to a cinching device for door latches in a vehicle, which may simultaneously cinches and operates a plurality of latches by use of one cinching actuator.

### Description of Related art

In general, a vehicle door, a hood, a trunk, a tailgate, or the like may separate the inside and the outside of a vehicle, block external noise, rain, dust, wind, or the like, and perform an important function of absorbing an impact together with a vehicle body structure to thus safely protect a passenger when a collision occurs.

There are various types of vehicle doors, including special-purpose doors, and hinged swing doors are most often applied to a passenger vehicle.

In general, the swing door refers to a door which is opened outwardly from a vehicle body around a hinge shaft provided through a hinge bracket between the door and the vehicle body. The present swing door may be easily opened and closed, and have a simple structure, thus allowing its easy maintenance and repair.

Meanwhile, some vehicles use an opposing swing door which has a large sense of openness when the door is opened and is advantageous for the passenger to enter or exit the vehicle.

The opposing swing door may be classified into a type without a B pillar and a type with a B pillar.

FIG. 1 is a side view showing a vehicle using a conventional opposing swing door.

Referring to FIG. 1, an opposing swing door applied in particular to a vehicle without a B pillar may include a front door 2 having a hinge shaft installed at a vehicle body 1 and a front end portion of the front door 2, and a rear door 3 having a hinge shaft installed at the vehicle body 1 and a rear end portion of the rear door 3.

The opposing swing door may include a door latch 4 to maintain a locking state of the front door 2 or the rear door 3.

The door latches 4 may each be disposed at lower and upper end portions of the front door 2, and disposed at the center portion of the rear end portion of the rear door 3. The door latch 4 is a device that regulates the opening and closing of the door, trunk, and tailgate of the vehicle. However, the door latch 4 has been replaced by a forced opening and closing method using an actuator such as a motor in accordance with a recent emphasis on convenience in the vehicle and an introduction of an intelligent part.

In the vehicle without a B pillar, at least one door is required to include two door latches 4, thus also requiring two cinching actuators to control operations of the two door latches 4.

FIG. 2 is a view showing an example of a conventional cinching device for door latches in a vehicle which is applied to the front door of the vehicle of FIG. 1.

FIG. 2 shows an example in which the upper and lower door latches 4 are applied to the front door 2 in FIG. 1, and the door may have upper and lower cinching actuators 6 respectively to control the operations of the upper and lower door latches 4. The upper and lower cinching actuators 6 may respectively be connected to the upper and lower door latches 4 through cables.

However, in the vehicle without a B pillar, the door having the two door latches 4 requires the two cinching devices 6, which is disadvantageous in terms of its weight and cost.

To overcome these disadvantages, research and development has been conducted to control the operations of two door latches by use of one cinching device. However, the two door latches 4, spaced apart from each other, may cause the different stroke distributions of their respective cables or their positional tolerances in a door panel, or the like, which may result in the door latches 4 each having a different cinching stroke.

Such different cinching strokes may cause the door not to be completely closed because one door latch is fastened to a striker while the other door latch is not fastened to the striker.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a cinching device for door latches in a vehicle, which may perform simultaneous cinching control while absorbing differences in cinching strokes of respective latches by coupling cable levers to a lead nut assembly which is moved along a lead screw by a driving force of one cinching actuator, and connecting the cable levers with the plurality of latches through a plurality of cinching cables.

According to an exemplary embodiment of the present disclosure, provided is a cinching device for door latches in a vehicle, which performs cinching control for a plurality of latches, the device including: a cinching actuator; a lead screw engaged to the cinching actuator and rotated by the cinching actuator; a lead nut assembly movably coupled to the lead screw; and a plurality of cable levers coupled to the lead nut assembly, and connected to the plurality of latches through respective cinching cables, wherein the cinching control is performed by absorbing a difference in cinching strokes of the plurality of latches through a spring structure for absorbing the stroke.

The cinching actuator may be a motor configured for controlling a rotation direction and number of rotations thereof.

The lead nut assembly may include a lead nut body engaged to the lead screw, and an upper lead nut and a lower lead nut each extending from one end portion of the lead nut body, disposed to be parallel to each other, respectively inserted into and connected to the plurality of cable levers.

A thread may be formed in the lead nut body to be engaged and coupled with the lead screw to thus be moved in a longitudinal direction of the lead screw in response to the rotation of the lead screw.

Each of the lead nut body, the upper lead nut, and the lower lead nut may include a rectangular parallelepiped shape.

A spring and a ball may be disposed in each of the upper lead nut and the lower lead nut, the spring configured for reciprocating by an elastic force in a direction perpendicular to an extension direction of the upper lead nut or the lower lead nut, and the ball being fixedly coupled to the spring.

The plurality of cable levers may include the upper cable lever and the lower cable lever into which the upper lead nut and the lower lead nut are respectively movably inserted, and a seating groove may be formed in a position of a surface corresponding to the ball in the upper cable lever or the lower cable lever for the ball to be inserted and accommodated in the seating groove or released from the seating groove.

Cable pins, to which the plurality of cinching cables are respectively fixed, may be disposed in the plurality of cable levers, and the plurality of cinching cables may respectively be guided by a plurality of end caps to thus be connected to the cable pins.

When the cinching control starts, the cinching actuator may be operated and the lead screw may be rotated to thus move the lead nut assembly, and the plurality of cable levers may be fixed to the lead nut assembly and operated to pull the plurality of cinching cables.

When any one of the plurality of cinching cables is completely locked, the cinching actuator may be continuously operated to move the lead nut assembly, the lead nut and the cable lever, connected to the cinching cable whose locking is completed, may be unfastened from each other, and the cable lever connected to the other cinching cable may be fixed to the lead nut and operated to pull the cinching cable until the other cinching cable is completely locked.

The lead nut and the cable lever may be unfastened from each other by the ball in the lead nut being separated from the seating groove in the cable lever and the spring being compressed.

The cinching device for door latches in a vehicle according to an exemplary embodiment of the present disclosure may perform the cinching control by operating the two latches using one cinching actuator. The cinching device may perform the simultaneous cinching control while absorbing the differences in the cinching strokes of the respective latches by including the lead nut which is moved along the lead screw by the driving force of one cinching actuator, and connecting the cable lever, coupled to the lead nut, to each of the two latches through the cinching cable.

the cinching device for door latches in a vehicle according to an exemplary embodiment of the present disclosure may control the dual latches required for the coach door without a B pillar by use of only one cinching actuator, removing a need for the other cinching actuator, and may absorb the differences in the cinching strokes occurring due to the tolerances of the surrounding parts, the cinching cables, or the like, reducing its cost and weight and enabling its common use.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a side view showing a vehicle using a conventional opposing swing door.

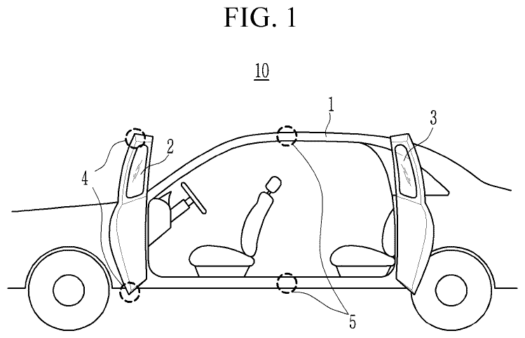

FIG. 2 is a view showing an example of a conventional cinching device for door latches in a vehicle which is applied to a front door of the vehicle of FIG. 1.

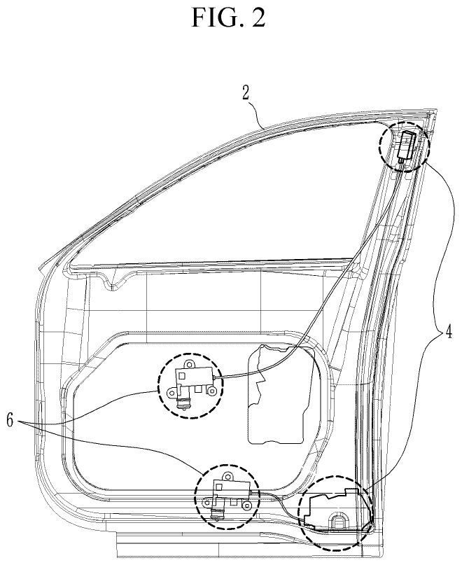

FIG. 3 is a perspective view of a front door using a cinching device for door latches in a vehicle according to an exemplary embodiment of the present disclosure.

FIG. 4 is an overall perspective view of the cinching device for door latches in a vehicle according to an exemplary embodiment of the present disclosure.

FIG. 5 is a plan view showing a usual state of the cinching device for door latches in a vehicle before performing its cinching function according to an exemplary embodiment of the present disclosure.

FIG. 6 is a plan view showing a state of the cinching device for door latches in a vehicle, in which the cinching function is performed and a two-stage locking of a lower latch is then completed according to an exemplary embodiment of the present disclosure.

FIG. 7 is an enlarged view of part ‘A’ of FIG. 6.

FIG. 8 is a plan view showing a state of the cinching device for door latches in a vehicle, in which the cinching function is performed, the two-stage locking of the lower latch is then preceded, and a two-stage locking of an upper latch is then completed to thus completely lock the door according to an exemplary embodiment of the present disclosure.

FIG. 9 is an enlarged view of part ‘B’ of FIG. 8.

FIG. 10 is a view showing a step-by-step operation state of the cinching device for door latches in a vehicle according to an exemplary embodiment of the present disclosure.

FIG. 11 is a plan view showing a state of the cinching device for door latches in a vehicle, in which the cinching function is performed, the two-stage locking of the upper latch is then preceded, and the two-stage locking of the lower latch is then completed to thus completely lock the door according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure are described in detail with reference to the accompanying drawings for those skilled in the art to which the present disclosure pertains to easily practice the present disclosure. The present disclosure may be modified in various different forms, and is not limited to the exemplary embodiments provided in the specification.

Furthermore, in several exemplary embodiments of the present disclosure, components having the same configuration are representatively described using the same reference numerals in an exemplary embodiment of the present disclosure, and only components different from those of an exemplary embodiment are described in the other embodiments.

It should be understood that the drawings are schematic and not drawn to scale. The size and proportion of a component in the drawings are shown relatively exaggerated or reduced in size for clarity and convenience in the drawings. The present arbitrary size is only illustrative and not limitative. Furthermore, the same reference numeral is used to denote a similar feature of the same structure, element, or part shown in two or more drawings. When it is described that an element is referred to as being “on” or “above” another element, it is to be understood that the element may be directly “on” another element or “above” another element having a third element interposed therebetween.

An exemplary embodiment of the present disclosure specifically represents an exemplary embodiment of the present disclosure. As a result, diagrams may be various modified. Accordingly, an exemplary embodiment of the present disclosure is not limited to a specific shape of the illustrated portion, and may include, for example, a shape modified when produced.

Hereinafter, a sliding door structure for a vehicle according to an exemplary embodiment of the present disclosure is described in detail with reference to the accompanying drawings.

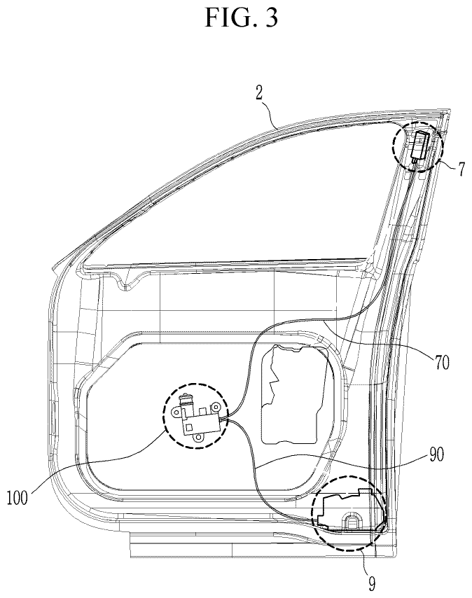

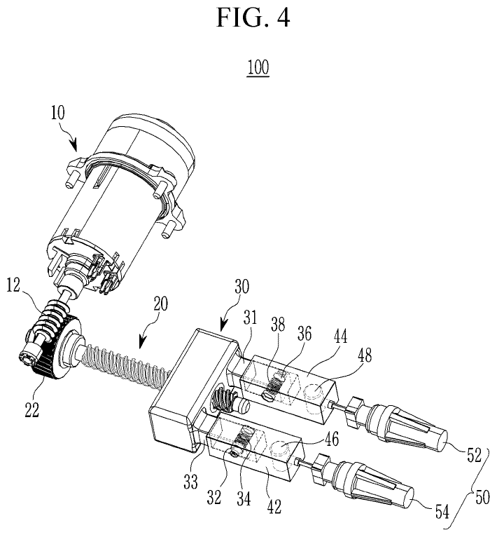

FIG. 3 is a perspective view of a front door using a cinching device for door latches in a vehicle according to an exemplary embodiment of the present disclosure; and FIG. 4 is an overall perspective view of the cinching device for door latches in a vehicle according to an exemplary embodiment of the present disclosure.

A cinching device 100 for door latches in a vehicle according to an exemplary embodiment of the present disclosure may not only be applied to door latches 7 and 9, but also be applied to a configuration including a dual latch structure such as a hood, a trunk, a tailgate, and a rear door of a pickup truck. However, in a vehicle without a B pillar, the cinching device 100 in an exemplary embodiment of the present disclosure may be applied to a door including two door latches, either the front door or the rear door, and the cinching device 100 in an exemplary embodiment of the present disclosure is described as an example applied to the front door.

Referring to FIG. 3 and FIG. 4, the cinching device 100 for door latches in a vehicle according to an exemplary embodiment of the present disclosure may include a cinching actuator 10, a lead screw 20, a lead nut assembly, and a plurality of cable levers 42 and 44.

The cinching device 100 for door latches in a vehicle may be provided in a door panel including the door latches 7 and 9 respectively disposed in upper and lower end portions thereof, in the vehicle without a B pillar. The cinching device 100 may perform simultaneous cinching control while absorbing differences in cinching strokes of the respective door latches 7 and 9 by moving the lead nut assembly along the lead screw 20 by a driving force of one cinching actuator 10, and connecting the cable levers 42 and 44 coupled to the lead nut assembly with two door latches 7 and 9 through two cinching cables 70 and 90.

The cinching actuator 10 may include a worm gear 12 provided on a rotation shaft thereof. The cinching actuator 10 may be a motor configured for controlling a rotation direction and number of rotations thereof.

The lead screw 20 may be disposed at a right angle to the rotation shaft of the cinching actuator 10, and include a worm wheel 22 mounted on an end portion thereof and engaged with the worm gear 12 to thus receive a rotational driving force of the cinching actuator 10 by gear drives of the worm gear 12 and the worm wheel 22.

The lead nut assembly may be movably fastened to the lead screw 20. The lead nut assembly may include a lead nut body 30 fastened to the lead screw 20, and an upper lead nut 31 and a lower lead nut 33 each extending from one end portion of the lead nut body 30 and disposed to be parallel to each other. The upper lead nut 31 and the lower lead nut 33 may respectively be inserted into and connected to the plurality of cable levers 44 and 42.

Each of the lead nut body 30, the upper lead nut 31, and the lower lead nut 33 may include a rectangular parallelepiped shape, and be moved forwards and backwards by the rotation of the lead screw 20 without using a separate guider or the like.

The plurality of cable levers 44 and 42 may be provided, and the upper and lower lead nuts 31 and 33 of the lead nut assembly may respectively be inserted into and connected to the cable levers 44 and 42. The plurality of cable levers 44 and 42 may be connected to the plurality of door latches 7 and 9 with the respective cinching cables.

Each of cable pins 46 and 48 may be connected to each front end portion of the cinching cables. The cable pins 46 and 48 may respectively be provided in the cable levers 44 and 42, and the cinching cables may respectively be guided by end caps 52 and 54 to thus be connected to the cable pins 46 and 48.

Meanwhile, a spring 34 or 38 and a ball 32 or 36 may be disposed in each of the upper lead nut 31 and the lower lead nut 33. The spring 34 or 38 may face an internal wall of the cable lever 44 or 42, that is, may be compressed and decompressed by an elastic force in a direction perpendicular to an extension direction of the upper lead nut 31 or the lower lead nut 33. The ball 32 or 36 may be fixed to an end portion of the spring 34 or 38 and in contact with the internal wall of the cable lever 44 or 42, thus compressing or decompressing the spring 34 or 38.

The cable levers 44 and 42 may include the upper cable lever 44 and the lower cable lever 42 into which the upper lead nut 31 and the lower lead nut 33 are respectively movably inserted, and a seating groove 43 may be formed in a position of an internal surface of the cable lever 44 or 42 that corresponds to that of the ball 32 or 36 for the ball 32 or 36 to be inserted and accommodated therein or released therefrom. The spring 34 or 38 may be decompressed when the ball 32 or 36 is accommodated in the seating groove 43, and the spring 34 or 38 may be compressed when the ball 32 or 36 is released from the seating groove 43.

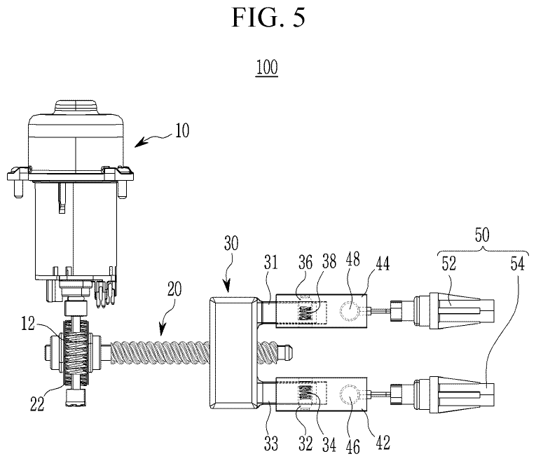

FIG. 5 is a plan view showing a usual state of the cinching device for door latches in a vehicle before performing its cinching function according to an exemplary embodiment of the present disclosure.

Referring to FIG. 5, the cinching cable may maintain its tension by the spring disposed in each of the two door latches 7 and 9. Therefore, the cable lever 44 or 42 may remain balanced and parallel to the lead nut assembly by a force balance.

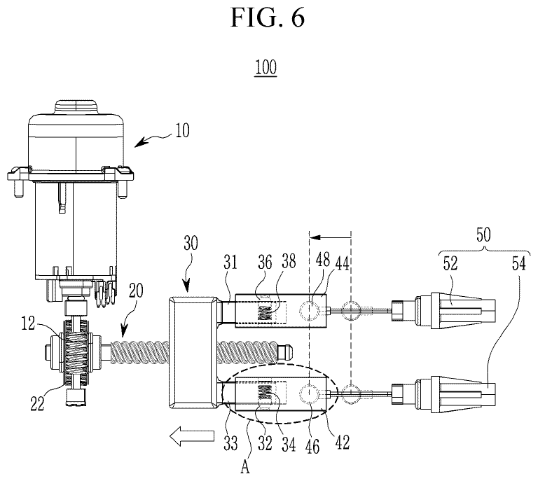

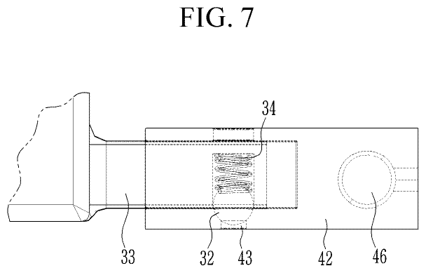

FIG. 6 is a plan view showing a state of the cinching device for door latches in a vehicle, in which the cinching function is performed and a two-stage locking of a lower latch is then completed according to an exemplary embodiment of the present disclosure; and FIG. 7 is an enlarged view of part ‘A’ of FIG. 6.

Referring to FIG. 6, when the cinching actuator 10 is rotated to perform the cinching operation for the two door latches 7 and 9, the lead screw 20 may be rotated by the gear drives of the worm gear 12 and the worm wheel 22, and the lead nut assembly coupled to the lead screw 20 may be moved to pull the cinching cable.

A thread may be formed in the lead nut body 30 of the lead nut assembly to be engaged and coupled with the lead screw 20 to thus be moved in a longitudinal direction of the lead screw 20 as the lead screw 20 is rotated. Therefore, the lead nut body 30 may be moved by the rotation of the lead screw 20, thus moving the lead nut assembly.

The cable lever 44 or 42 may then be moved together with the lead nut assembly to thus pull the cinching cable. An end portion of the cinching cable may be fixed by the cable pin 46 or 48, thus allowing the cinching cable to be pulled when the cable lever 44 or 42 is moved.

Accordingly, the door latches 7 and 9 may start their cinching operations by the cinching strokes of the cinching cables, and one door latch may complete the two-stage locking first. The present exemplary embodiment shows a case where the lower latch 9 completes the two-stage locking first.

Here, the other door latch, that is, the upper latch 7, may not complete the two-stage locking due to a difference in the cinching strokes, and the corresponding door may thus be incompletely locked. As shown in FIG. 7, the ball 32 of the lower lead nut 33 may be accommodated in the seating groove 43 of the lower cable lever 42, and the spring 34 may be decompressed.

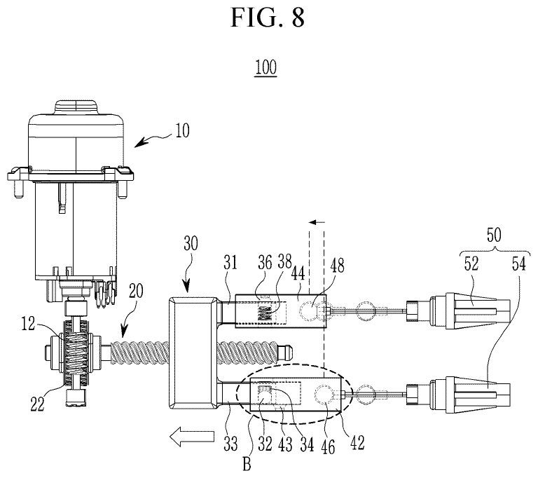

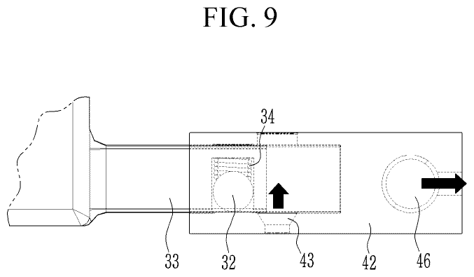

FIG. 8 is a plan view showing a state of the cinching device for door latches in a vehicle, in which the cinching function is performed, the two-stage locking of the lower latch is then preceded, and the two-stage locking of the upper latch is then completed to thus completely lock the door according to an exemplary embodiment of the present disclosure; and FIG. 9 is an enlarged view of part ‘B’ of FIG. 8.

Referring to FIG. 8, when the cinching actuator 10 is continuously rotated, the lead screw 20 may be rotated by the gear drives of the worm gear 12 and the worm wheel 22, and the lead nut assembly coupled to the lead screw 20 may be moved to pull the cinching cable.

The cinching cable connected to the upper latch 7, which is the other latch other than the lower latch 9 whose two-stage locking is completed, may then be pulled, and the differences in the cinching strokes may thus be absorbed. Accordingly, the upper latch 7 may also be in a two-stage locking state by the cinching operation, thus completely locking the door.

Here, as shown in FIG. 9, the cinching cable connected to the lower cable lever 42 may not be pulled due to a resistance caused by the completion of the two-stage locking, and only the lower lead nut 33 may thus be moved. Accordingly, the ball 32 of the lower lead nut 33, which is accommodated in the seating groove 43 of the lower cable lever 42, may be released, and the spring 34 may be decompressed, thus allowing the ball 32 to slide along the internal surface of the lower cable lever 42. That is, the cinching cable connected to the lower cable lever 42 may not be pulled by being fixed.

On the other hand, the cinching cable connected to the upper cable lever 44 may be pulled and moved together with the upper cable lever 44 until the cinching cable is unable to be pulled any longer because its two-stage locking is completed. Therefore, the difference between the stroke of the cinching cable connected to the lower latch 9 and the stroke of the cinching cable connected to the upper latch 7 may be absorbed at a time interval

For the present cinching operation, the operation of the cinching actuator 10 may be controlled through control logic for the cinching actuator 10 to be operated until a lock signal is input from lock switches of the two door latches 7 and 9.

In an exemplary embodiment of the present disclosure, the control logic includes a controller having a processor.

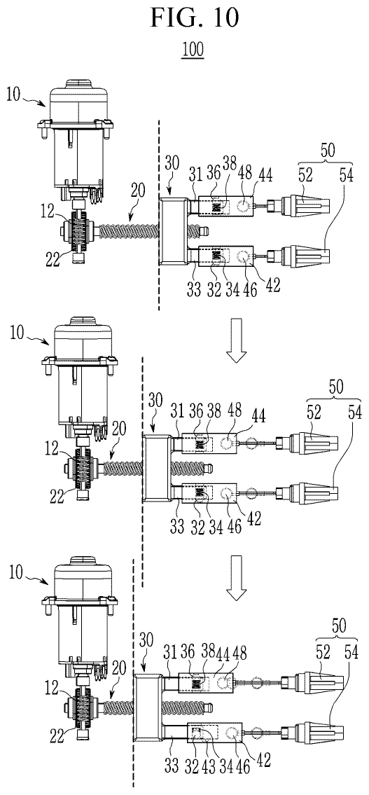

FIG. 10 is a view showing a step-by-step operation state of the cinching device for door latches in a vehicle according to an exemplary embodiment of the present disclosure.

Referring to FIG. 10, as described with reference to FIG. 5, FIG. 6, FIG. 7, FIG. 8, and FIG. 9, in the cinching device 100 for door latches in a vehicle according to an exemplary embodiment of the present disclosure, in its usual state before performing the cinching function, when the cinching actuator 10 is rotated to start the cinching operation for the two door latches 7 and 9, the lead nut assembly may be moved along the lead screw 20 toward the cinching actuator 10.

When the lower latch 9 completes the two-stage locking first, and the cinching cable connected to the lower cable lever 42 is no longer pulled, the cinching actuator 10 may be continuously rotated to thus move the lead nut assembly further toward the cinching actuator 10 along the lead screw 20, and the ball 32 or 36 of the lower lead nut 33 may be released from the seating groove 43 in the lower cable lever 42 of the lower latch 9 whose two-stage locking is completed.

The upper cable lever 44 may be continuously pulled by the upper lead nut 31 when the cinching cable connected to the lower cable lever 42 is no longer pulled, thus allowing the cinching cable connected to the upper cable lever 44 to be pulled.

When the cinching cable connected to the upper cable lever 44 is no longer pulled, the two-stage locking of the upper latch 7 may be completed, and the difference in the cinching strokes may be absorbed in the present process.

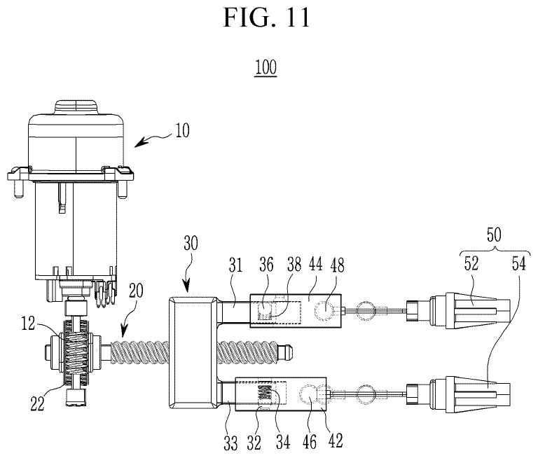

FIG. 11 is a plan view showing a state of the cinching device for door latches in a vehicle, in which the cinching function is performed, the two-stage locking of the upper latch is then preceded, and the two-stage locking of the lower latch is then completed to thus completely lock the door according to an exemplary embodiment of the present disclosure.

FIG. 11 shows a case opposite to the case described with reference to FIG. 10 where the two-stage locking of the lower latch 9 is preceded, and the two-stage locking of the upper latch 7 is then completed. FIG. 11 shows that the upper latch 7 completes the two-stage locking first, and the lower latch 9 then completes the two-stage locking, whose operation principle is the same as that shown in FIG. 10, and the description thus omits its further description.

As set forth above, the cinching device for door latches in a vehicle according to an exemplary embodiment of the present disclosure may perform the cinching control by operating the two latches using one cinching actuator. The cinching device may perform the simultaneous cinching control while absorbing the differences in the cinching strokes of the respective latches by including the lead nut which is moved along the lead screw by the driving force of one cinching actuator, and connecting the cable levers, coupled to the lead nut, to the two latches through the respective cinching cables.

the cinching device for door latches in a vehicle according to an exemplary embodiment of the present disclosure may be configured for controlling the dual latches required for the coach door without a B pillar by use of only one cinching actuator, removing a demand for the other cinching actuator, and may absorb the differences in the cinching strokes occurring due to the tolerances of the surrounding parts, the cinching cables, or the like, reducing its cost and weight and enabling its common use.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A cinching apparatus for door latches in a vehicle, which performs cinching control for a plurality of latches, the apparatus comprising:
a cinching actuator;
a lead screw engaged to the cinching actuator and rotated by the cinching actuator;
a lead nut assembly movably coupled to the lead screw; and
a plurality of cable levers coupled to the lead nut assembly, and connected to the plurality of latches through respective cinching cables,
wherein the cinching control is performed by absorbing a difference in cinching strokes of the plurality of latches through a spring structure for absorbing the cinching strokes.

2. The apparatus of claim 1, wherein the cinching actuator is a motor configured for controlling a rotation direction and number of rotations thereof.

3. The apparatus of claim 1, wherein the lead nut assembly includes:
a lead nut body engaged to the lead screw, and
at least two lead nuts each extending from one end portion of the lead nut body, disposed to be parallel to each other, respectively inserted into and connected to the plurality of cable levers.

4. The apparatus of claim 3,
wherein the spring structure includes a spring and a ball, and
wherein the spring and the ball are disposed in each of the at least two lead nuts, the spring configured for reciprocating by an elastic force in a direction perpendicular to an extension direction of the at least two lead nuts, and the ball being fixedly coupled to the spring.

5. The apparatus of claim 4, wherein a seating groove is formed in a position of a surface corresponding to the ball in at least one of the plurality of cable levers for the ball to be inserted and accommodated in the seating groove or released from the seating groove.

6. The apparatus of claim 3, wherein the at least two lead nuts include an upper lead nut and a lower lead nut each extending from the one end portion of the lead nut body, disposed to be parallel to each other, respectively inserted into and connected to the plurality of cable levers.

7. The apparatus of claim 6, wherein a thread is formed in the lead nut body to be engaged and coupled with the lead screw to thus be moved in a longitudinal direction of the lead screw in response to the rotation of the lead screw.

8. The apparatus of claim 6, wherein each of the lead nut body, the upper lead nut, and the lower lead nut includes a rectangular parallelepiped shape.

9. The apparatus of claim 6,
wherein the spring structure includes a spring and a ball, and
wherein the spring and the ball are disposed in each of the upper lead nut and the lower lead nut, the spring configured for reciprocating by an elastic force in a direction perpendicular to an extension direction of the upper lead nut or the lower lead nut, and the ball being fixedly coupled to the spring.

10. The apparatus of claim 9,
wherein the plurality of cable levers include an upper cable lever and a lower cable lever into which the upper lead nut and the lower lead nut are respectively movably inserted, and
wherein a seating groove is formed in a position of a surface corresponding to the ball in the upper cable lever or the lower cable lever for the ball to be inserted and accommodated in the seating groove or released from the seating groove.

11. The apparatus of claim 1, wherein cable pins, to which the plurality of cinching cables are respectively fixed, are disposed in the plurality of cable levers.

12. The apparatus of claim 11, further including a plurality of end caps,
wherein the plurality of cinching cables are respectively guided by the plurality of end caps to thus be connected to the cable pins.

13. The apparatus of claim 10, wherein in response that the cinching control starts, the cinching actuator is operated and the lead screw is rotated to thus move the lead nut assembly, and the plurality of cable levers are fixed to the lead nut assembly and operated to pull the plurality of cinching cables.

14. The apparatus of claim 13, wherein in a state that any one of the plurality of cinching cables is completely locked,
the cinching actuator is continuously operated to move the lead nut assembly, the lead nut and the cable lever, connected to the cinching cable whose locking is completed among the cinching cables, are unfastened from each other, and
the cable lever connected to the other cinching cable among the cinching cables is fixed to the lead nut and operated to pull the cinching cable until the other cinching cable is completely locked.

15. The apparatus of claim 14, wherein the lead nut and the cable lever are unfastened from each other by the ball in the lead nut being separated from the seating groove in the cable lever and the spring being compressed.

16. The apparatus of claim 1, wherein the lead screw is disposed at a right angle to a rotation shaft of the cinching actuator, and include a worm wheel mounted on an end portion of the rotation shaft and engaged with a worm gear mounted on an end of the lead screw to thus receive a rotational driving force of the cinching actuator by the worm gear and the worm wheel.
